(19) United States
(12) Patent Application Publication
(10) Pub. No.: US 2026/0329809 A1
(43) Pub. Date: Oct. 22, 2026

(54) System and Method for Managing Storage Resources of Disaggregated Storage Systems

(71) Applicant: NETAPP, INC., San Jose, CA (US)

(72) Inventors: Bulli Venkata Rajesh Vipperla, Morrisville, NC (US); Ananthan Subramanian, San Ramon, CA (US); Anil Paul Thoppil, Pleasanton, CA (US); Travis Ian Callahan, Apex, NC (US)

(21) Appl. No.: 19/186,266

(22) Filed: Apr. 22, 2025

(51) Int. Cl. G06F 16/13

(52) U.S. Cl. CPC G06F 16/13

(57) ABSTRACT

A method and system, in response to an instruction to move ownership of unused accessible storage units of storage space of a collection of storage devices from a source dynamically extensible file system running on a first node to a target dynamically extensible file system running on a second node, updates data structures of the source and target dynamically extensible file systems to release and assign ownership of a group of storage devices from the source dynamically extensible file system to the target dynamically extensible file system. Accessible storage units of the group of storage devices that belong to the target dynamically extensible file system are added to an ownership storage object of the target dynamically extensible file system, after scanning a designated storage region of the collection of storage devices to search for entries of accessible storage units in the group of storage devices that belong to the target dynamically extensible file system.

### TECHNICAL FIELD

The present disclosure relates to storage systems, and more particularly to disaggregated storage systems.

### BACKGROUND

Traditional storage architectures, such as direct-attached storage and software-defined storage, have scalability limitations and inefficient resource utilization. In these storage systems, storage capacity and compute power typically need to be scaled together, which may result in over-provisioning resources and increased operational costs. Additionally, data bottlenecks can arise due to constrained storage access, which may impact system performance.

Disaggregated storage systems address these challenges by decoupling storage resources from compute resources, which allows each to be scaled independently. The disaggregated storage systems may utilize high-speed network protocols to enable efficient data transfers between storage devices and compute nodes. By separating the storage and compute resources, the disaggregated storage systems can improve flexibility, enhance performance and optimize resource allocation. Thus, disaggregated storage systems are beneficial in cloud computing environments, large-scale data centers, and applications requiring high-performance storage access, such as artificial intelligence and big data analytics. However, there is a need to efficiently manage storage resources in disaggregated storage systems to optimize usability and operability.

### SUMMARY

A method and system, in response to an instruction to move ownership of unused accessible storage units of storage space of a collection of storage devices from a source dynamically extensible file system running on a first node to a target dynamically extensible file system running on a second node, updates data structures of the source and target dynamically extensible file systems to release and assign ownership of a group of storage devices from the source dynamically extensible file system to the target dynamically extensible file system. Accessible storage units of the group of storage devices that belong to the target dynamically extensible file system are added to an ownership storage object of the target dynamically extensible file system, after scanning a designated storage region of the collection of storage devices to search for entries of accessible storage units in the group of storage devices that belong to the target dynamically extensible file system.

A method executed by one or more processors in accordance with an embodiment comprises, in response to an instruction to move ownership of unused accessible storage units of storage space of a collection of storage devices from a source dynamically extensible file system running on a first node to a target dynamically extensible file system running on a second node, updating a first data structure of the source dynamically extensible file system to release ownership of a group of storage devices from the source dynamically extensible file system and a second data structure of the target dynamically extensible file system to assign ownership of the group of storage devices to the target dynamically extensible file system, scanning a designated storage region of the collection of storage devices to search for entries of accessible storage units in the group of storage devices that belong to the target dynamically extensible file system, and adding the accessible storage units of the group of storage devices that belong to the target dynamically extensible file system to an ownership storage object of the target dynamically extensible file system. In some embodiments, the steps of this method are performed when program instructions contained in a non-transitory computer-readable storage medium are executed by one or more processors.

A system in accordance with an embodiment of the invention comprises memory and at least one processor configured to, in response to an instruction to move ownership of unused accessible storage units of storage space of a collection of storage devices from a source dynamically extensible file system running on a first node to a target dynamically extensible file system running on a second node, update a first data structure of the source dynamically extensible file system to release ownership of a group of storage devices from the source dynamically extensible file system and a second data structure of the target dynamically extensible file system to assign ownership of the group of storage devices to the target dynamically extensible file system, scan a designated storage region of the collection of storage devices to search for entries of accessible storage units in the group of storage devices that belong to the target dynamically extensible file system, and add the accessible storage units of the group of storage devices that belong to the target dynamically extensible file system to an ownership storage object of the target dynamically extensible file system.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

The foregoing features and other features will now be described with reference to the drawings of the various aspects of the present disclosure. In the drawings, the same components have the same reference numerals, and similar reference numbers may be used to identify similar elements. The illustrated aspects are intended to illustrate, but not to limit the present disclosure. The drawings include the following figures.

FIG. 1 shows a computing environment in which embodiments of the disclosure may be implemented.

FIG. 2 shows components of a representative node of a disaggregated storage system in the computing environment in accordance with an embodiment of the disclosure.

FIG. 3 shows a storage operating system in accordance with an embodiment of the disclosure.

FIG. 4 shows a tree of blocks representing of an example a file system layout in accordance with an embodiment of the disclosure.

FIG. 5 shows various components of the disaggregated storage system that provides disaggregated storage in accordance with an embodiment of the disclosure.

FIG. 6 is a flow diagram of a disk-add operation performed by a new-RG-owner dynamically extensible file system (DEFS) in accordance with an embodiment of the disclosure.

FIG. 7 illustrates the disk-add operation on the disaggregated storage system in accordance with an embodiment of the disclosure.

FIG. 8 is a flow diagram of an allocation area (AA)-move operation when a user wants to move any pristine A As owned by a corrupt DEFS to a target DEFS in accordance with an embodiment of the disclosure.

FIG. 9 is a flow diagram of a handshake operation for handling addition of disks during an upgrade process in accordance with an embodiment of the disclosure.

FIG. 10 is a flow diagram of a handshake operation to change the new RG owner from a first DEFS to a second DEFS in accordance with an embodiment of the disclosure.

FIG. 11 is a flow diagram of a method executed by one or more processors in accordance with an embodiment of the disclosure.

FIG. 12 is a flow diagram of another method executed by one or more processors in accordance with an embodiment of the disclosure.

FIG. 13 is a high-level block diagram showing an example of the architecture of a processing system in accordance with an embodiment of the disclosure.

### DETAILED DESCRIPTION

As preliminary note, the terms “component”, “module”, “system,” and the like as used herein are intended to refer to a computer-related entity, either software-executing general-purpose processor, hardware, firmware and a combination thereof. For example, a component may be, but is not limited to being, a process running on a processor, a hardware-based processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can be executed from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, at non-transitory, computer readable media including, but not limited to, an ASIC (application specific integrated circuit), CD (compact disc), DVD (digital video disk), ROM (read only memory), solid state drive, hard disk, EEPROM (electrically erasable programmable read only memory), non-volatile memory or any other storage device, in accordance with the claimed subject matter.

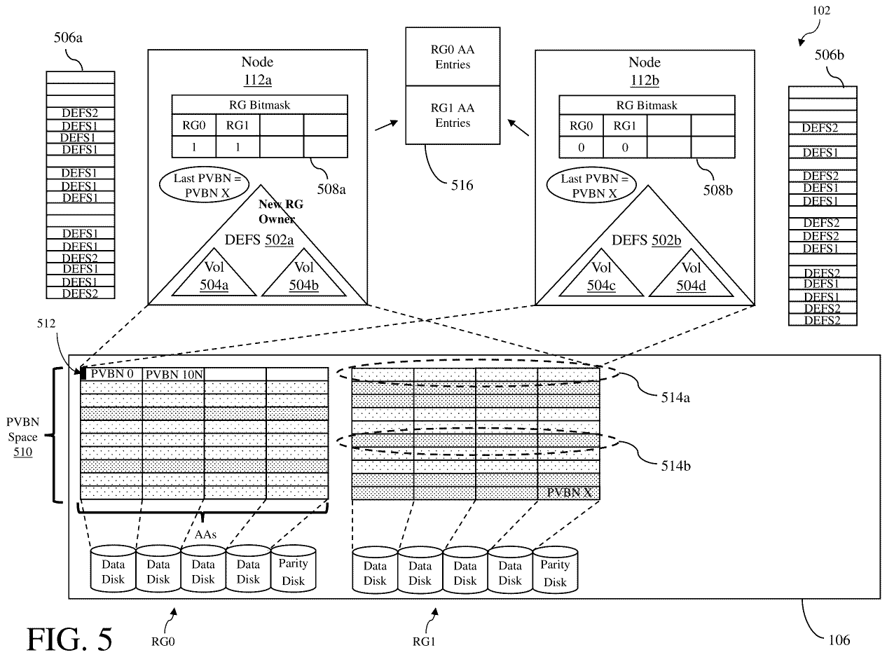

In various examples described herein, disk space may be used more fluidly across all the individual storage systems (e.g., nodes) of a distributed storage system (e.g., a cluster of nodes working together), thereby eliminating silos of storage; and processing resource (e.g., central processing unit (CPU)) load may be distributed across the cluster. The proposed architecture seeks to prevent a given disk from being tied to any single node of the cluster by introducing a new construct referred to herein as a “dynamically extensible file system,” examples of which are described further below with reference to FIG. 5. In contrast to the entirety of a given storage device (e.g., a disk) being owned by a node-level aggregate and the aggregate file system being visible from only one node of a cluster, the use of dynamically extensible file systems facilitates visibility by all nodes in the cluster to the entirety of a global physical volume block number (PVBN) space of the disks associated with a single “storage pod” (another new construct introduced herein) that may be shared by all of the nodes of the cluster with space from the global PV BN space being used on demand.

In one embodiment, each node of a cluster has access to do read and write to all the disks in a storage pod associated with a cluster. Given all the nodes have access to the same disks, a RAID subsystem or layer can now assimilate the same RAID tree from the same set of disks and present the global PV BN space to the file system (e.g., a write anywhere file system, such as the write anywhere file layout (WAFL) file system available from NetApp, Inc. of San Jose, CA). Using the global PVBN space, each node of the cluster can create an independent file system that it needs. As those skilled in the art will appreciate, it would be dangerous for each node to allocate from the same global PVBN space independently and without limitation. As such, examples of the proposed architecture restrict each dynamically extensible file system to use (consume) space only from the blocks assigned to it. As such, when performing writes, each dynamically extensible file system stays in its own lane without the need for complex access control mechanisms, such as locks.

As described further below, in some examples, the association of blocks to a dynamically extensible file system may be in large chunks of one or more gigabytes (GB), which are referred to herein as “allocation areas” (AAs) that each include multiple RAID stripes. The use of large, multi-GB chunks, as the unit of space allocation/assignment to dynamically extensible file systems facilitates ease of management (e.g., by way of reducing the frequency of ownership transfers among dynamically extensible file systems) of these AAs. The assignment of AAs to individual dynamically extensible file systems, which in turn are owned by nodes, additionally helps each node do its write allocation independently since, by definition an entire RAID stripe is owned by a single dynamically extensible file system. In some embodiments, dynamically extensible file systems also minimize or at least significantly reduce the need for internode communications. For example, dynamically extensible file systems can limit their coordination across nodes to situations in which space balancing is to be performed (e.g., responsive to a node running low on free storage space relative to the other nodes), which is not a frequent operation. Responsive to a space balancing trigger event, a given dynamically extensible file system (or the node owning given dynamically extensible file system on behalf of the given dynamically extensible file system) may request space be reassigned to it from one or more other dynamically extensible file systems. The combination of visibility into the entire global PV BN space and the use of dynamically extensible file systems and their association with a given portion of the disaggregated storage of a storage pod to which a given dynamically extensible file system has exclusive write access enables each node to run independently most of the time.

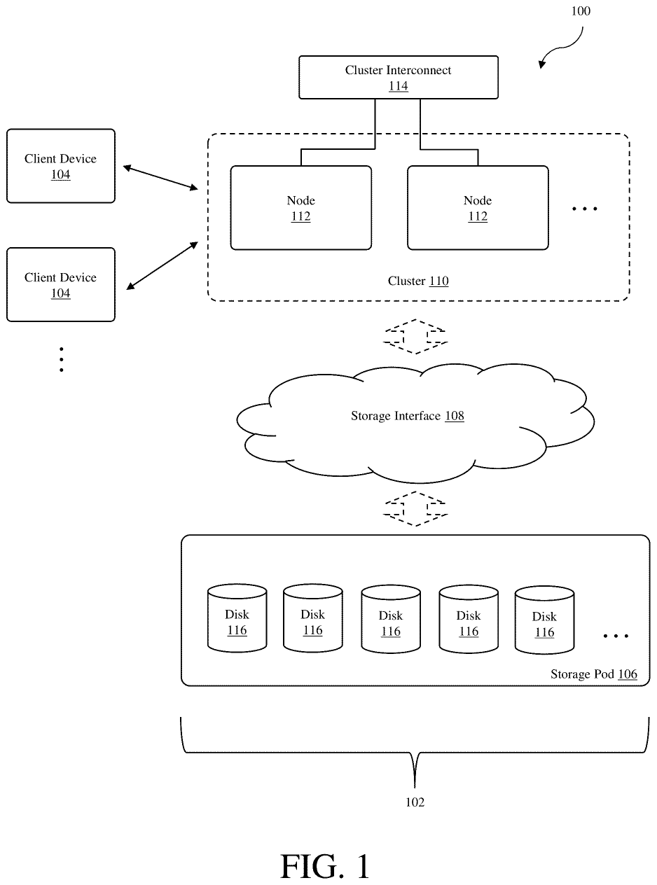

Turning now to FIG. 1, a computing environment 100 in which embodiments of the disclosure may be implemented is illustrated. The computing environment 100 includes a disaggregated storage system 102 that can be accessed by one or more client devices 104.

The client devices 104 may be any type of computing systems, such as personal computers, laptops, mobile devices and servers, that can interact with the disaggregated storage system 102 to execute file system (FS) operations, such as read and write operations. The client devices 104 may interact with the disaggregated storage system 102 using file-based access protocols, such as the Common Internet File System (CIFS) protocol or Network File System (NFS) protocol, over the Transmission Control Protocol/Internet Protocol (TCP/IP) when accessing information in the disaggregated storage system 102 in the form of files and directories. Alternatively, the client devices 104 may interact with the disaggregated storage system 102 using block-based access protocols, such as the Small Computer Systems Interface (SCSI) protocol encapsulated over TCP (ISCSI) and SCSI encapsulated over Fibre Channel (FCP), when accessing information in the disaggregated storage system 102 in the form of blocks. These protocols may be entered using a user interface (UI) or a command line interface (CLI) to interface with the disaggregated storage system 102.

As shown in FIG. 1, the disaggregated storage system 102 includes a storage pod 106, a storage interface 108, a cluster 110 of nodes 112, and a cluster interconnect 114. The storage pod 106 is a collection or group of physical storage resources or storage devices 116, such as hard disk drives (HDDs), solid-state drives (SSD), optical discs, and flash drives. These storage devices 116 will be generally referred to herein as “disks” with the understanding that the disks can be any type of physical storage devices. The nodes 112 are computing devices that can execute operations related to data stored in the disks 116 of the storage pod 106. The nodes 112 can access the disks 116 of the storage pod 106 via the storage interface 108, which allows the nodes 112 to access any of the disks 116 using, for example, one or more fiber channel switches or one or more non-volatile memory express (NVMe) fabric switches. The nodes 112 may also communicate with each other though the cluster interconnect 112, which can include at least one switch, such as a Gigabit Ethernet switch.

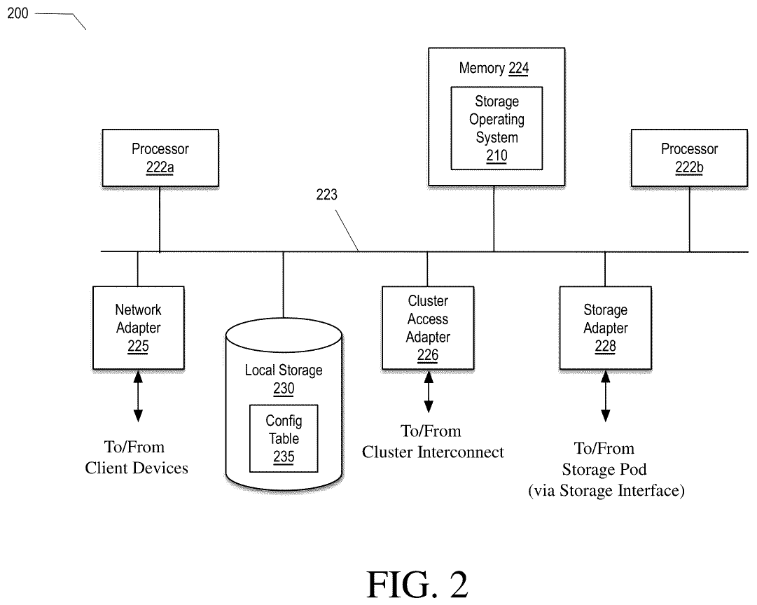

Turning now to FIG. 2, a representative node 200 of the nodes 112 in the disaggregated storage system 102 in accordance with an embodiment of the disclosure is shown. As shown in FIG. 2, the node 200 one or more processors, such as processors 222a and 222b, a memory 224, a network adapter 225, a cluster access adapter 226, a storage adapter 228 and local storage 230 interconnected by a system bus 223. The local storage 230 may include one or more storage devices, such as HH Ds and/or SSDs, utilized by the node 200 to locally store configuration information (e.g., in a configuration table 235). The cluster access adapter 226 comprises a plurality of ports adapted to couple the node 200 to other nodes of the cluster (e.g., the cluster 110). Illustratively, Ethernet may be used as the clustering protocol and interconnect media, although it will be apparent to those skilled in the art that other types of protocols and interconnects may be utilized within the cluster architecture described herein.

In the illustrated embodiment, the node 200 is a dual processor storage system executing a storage operating system 210 that implements a high-level module, such as a file system, to logically organize the information as a hierarchical structure of named directories, files and special types of files called virtual disks (hereinafter generally “blocks”) on the disks. However, it will be apparent to those of ordinary skill in the art that the node 200 may alternatively be a single or more than two processor system.

The memory 224 may include storage locations that are addressable by the processors and adapters for storing software program code and data structures associated with the subject matter of the disclosure. The processor and adapters may, in turn, comprise processing elements and/or logic circuitry configured to execute the software code and manipulate the data structures. The storage operating system 210, portions of which are typically resident in memory and executed by the processing elements, functionally organizes the node 200 by, inter alia, invoking storage operations in support of the storage service implemented by the node. It will be apparent to those skilled in the art that other processing and memory means, including various computer readable media, may be used for storing and executing program instructions pertaining to the disclosure described herein.

The network adapter 225 may include a plurality of ports adapted to couple the node 200 to one or more client devices (e.g., the client devices 104) over point-to-point links, wide area networks, virtual private networks implemented over a public network (Internet) or a shared local area network. The network adapter 225 thus may comprise the mechanical, electrical and signaling circuitry needed to connect the node 200 to a network to communicate with client devices.

The storage adapter 228 cooperates with the storage operating system 210 executing on the node 200 to access information requested by client devices. The information may be stored on any type of attached array of writable storage device media such as video tape, optical, DVD, magnetic tape, bubble memory, electronic random access memory, micro-electromechanical and any other similar media adapted to store information, including data and parity information. However, as illustratively described herein, the information is stored on disks (e.g., associated with the storage pod 106). The storage adapter comprises a plurality of ports having input/output (I/O) interface circuitry that couples to the disks over an I/O interconnect arrangement, such as a conventional high-performance, FC link topology.

Storage of information on each disk array may be implemented as one or more storage “volumes” that comprise a collection of physical storage disks or cloud volumes cooperating to define an overall logical arrangement of volume block number (VBN) space on the volume(s). Each logical volume is generally, although not necessarily, associated with its own file system. The disks within a logical volume/file system are typically organized as one or more groups, wherein each group may be operated as a Redundant Array of Independent (or Inexpensive) Disks (RAID). Most RAID implementations, such as a RAID-4 level implementation, enhance the reliability/integrity of data storage through the redundant writing of data “stripes” across a given number of physical disks in the RAID group, and the appropriate storing of parity information with respect to the striped data. An illustrative example of a RAID implementation is a RAID-4 level implementation, although it should be understood that other types and levels of RAID implementations may be used in accordance with the inventive principles described herein.

As an example, the storage operating system 210 may provide a set of logical storage volumes (or LUNs)) that present storage space to the client device 104 for storing information. Each volume can be configured to store data containers (e.g. files, directories, structured or unstructured data, or data objects), scripts, word processing documents, executable programs, and any other type of structured or unstructured data. From the perspective of one of the client devices, each volume can appear to be a single drive. However, each volume can represent storage space at one storage device, an aggregate of some or all of the storage space in multiple storage devices, a RAID group, or any other suitable set of storage space. The term file/files as used herein include data container/data containers, directory/directories, and/or data object/data objects with structured or unstructured data.

While in the context of the present example, the node 200 may be a physical host computer. However, the node 200 may be implemented in virtual form, s. For example, a storage system may be run (e.g., on a VM or as a containerized instance, as the case may be) within a public cloud provider. As such, the cluster 110 may include multiple physical nodes and/or virtual nodes.

To facilitate access to the disks 116, the storage operating system 210 may implement a write-anywhere file system that cooperates with one or more virtualization modules to “virtualize” the storage space provided by the disks. The file system logically organizes the information as a hierarchical structure of named directories and files on the disks. Each “on-disk” file may be implemented as set of disk blocks configured to store information, such as data, whereas the directory may be implemented as a specially formatted file in which names and links to other files and directories are stored. The virtualization modules allow the file system to further logically organize information as a hierarchical structure of blocks on the disks that are exported as named logical unit numbers (LUNs).

Illustratively, the storage operating system 210 may be the Data ONTAP operating system available from NetApp, Inc., San Jose, Calif. that implements the write anyway file layout (WAFL) file system. However, it is expressly contemplated that any appropriate storage operating system may be enhanced for use in accordance with the inventive principles described herein. As such, where the term “WAFL” is employed, it should be taken broadly to refer to any file system that is otherwise adaptable to the teachings of this disclosure.

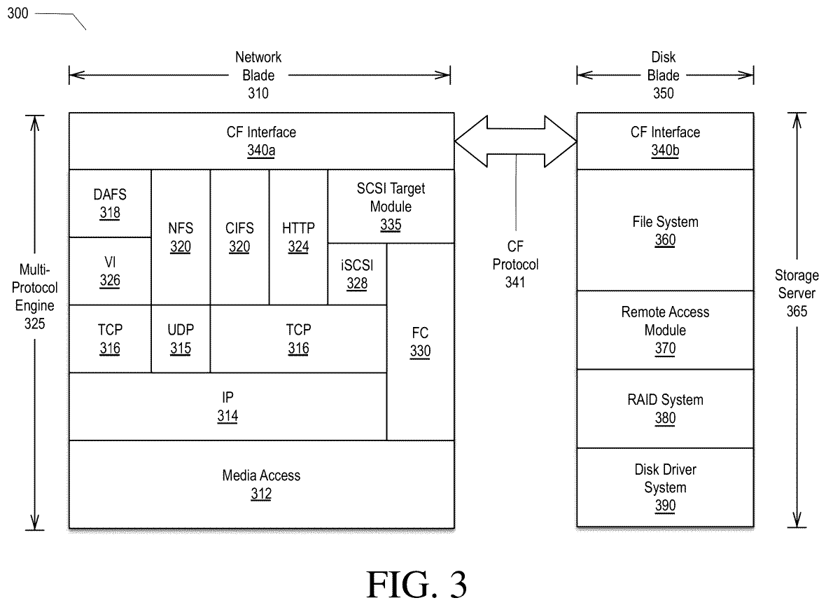

Turning now to FIG. 3, components of the storage operating system 210 in accordance with an embodiment of the disclosure are shown. In the context of the present example, the storage operating system 210 is shown to include a series of software layers organized to form an integrated network protocol stack or, more generally, a multi-protocol engine 325 that provides data paths for client devices to access information stored on the node 200 using block and file access protocols. The multi-protocol engine 325 includes a media access layer 312 of network drivers (e.g., gigabit Ethernet drivers) that interfaces to network protocol layers, such as the IP layer 314 and its supporting transport mechanisms, the TCP layer 316 and the User Datagram Protocol (UDP) layer 315. A file system protocol layer provides multi-protocol file access and, to that end, includes support for the Direct Access File System (DA FS) protocol 318, the NFS protocol 320, the CIFS protocol 322 and the Hypertext Transfer Protocol (HTTP) protocol 324. A virtual interface (VI) layer 326 implements the VI architecture to provide direct access transport (DAT) capabilities, such as remote direct memory access (RDMA), as required by the DA FS protocol 318. An iSCSI driver layer 328 provides block protocol access over the TCP/IP network protocol layers, while an FC driver layer 330 receives and transmits block access requests and responses to and from the node. The FC and ISCSI drivers provide FC-specific and ISCSI-specific access control to the blocks and, thus, manage exports of LUNs to either ISCSI or FCP or, alternatively, to both ISCSI and FCP when accessing the blocks on the node.

In addition, the storage operating system may include a series of software layers organized to form a storage server 365 that provides data paths for accessing information stored on the disks of the node. To that end, the storage server 365 includes a file system module 360 in cooperating relation with a remote access module 370, a RAID system module 380 and a disk driver system module 390. The RAID system 380 manages the storage and retrieval of information to and from the volumes/disks in accordance with I/O operations, while the disk driver system 390 implements a disk access protocol such as, e.g., the SCSI protocol.

The file system 360 may implement a virtualization system of the storage operating system 210 through the interaction with one or more virtualization modules illustratively embodied as, for example, a virtual disk (vdisk) module (not shown) and a SCSI target module 335. The SCSI target module 335 is generally disposed between the FC and ISCSI drivers 328, 330 and the file system 360 to provide a translation layer of the virtualization system between the block (LUN) space and the file system space, where LUNs are represented as blocks.

The file system 360 may be a message-based system that provides logical volume management capabilities for use in access to the information stored on the storage devices, such as disks. That is, in addition to providing file system semantics, the file system 360 provides functions normally associated with a volume manager. These functions include (i) aggregation of the disks, (ii) aggregation of storage bandwidth of the disks, and (iii) reliability guarantees, such as mirroring and/or parity (RAID). The file system 360 may have an on-disk format representation that is block-based using, e.g., 4 kilobyte (KB) blocks and using index nodes (“inodes”) to identify files and file attributes (such as creation time, access permissions, size and block location). The file system uses files to store metadata describing the layout of its file system. These metadata files may include, among others, an inode file. A file handle, i.e., an identifier that includes an inode number, may be used to retrieve an inode from disk.

In general, all inodes of the write-anywhere file system may be organized into the inode file. A file system (fs) info block specifies the layout of information in the file system and includes an inode of a file that includes all other inodes of the file system. Each logical volume (file system) has an fsinfo block that is preferably stored at a fixed location within, e.g., a RAID group. The inode of the inode file may directly reference (point to) data blocks of the inode file or may reference indirect blocks of the inode file that, in turn, reference data blocks of the inode file. Within each data block of the inode file are embedded inodes, each of which may reference indirect blocks that, in turn, reference data blocks of a file.

Operationally, a request from a client device may be forwarded as a packet over a computer network and onto the node 200 where it is received at the network adapter 225. A network driver of the layer 312 or 330 processes the packet and, if appropriate, passes it on to a network protocol and file access layer for additional processing prior to forwarding to the write-anywhere file system 360. Here, the file system generates operations to load (retrieve) the requested data from disk if it is not resident “in core”, i.e., in the memory 224. If the information is not in memory, the file system 360 indexes into the inode file using the inode number to access an appropriate entry and retrieve a logical VBN. The file system then passes a message structure including the logical VBN to the RAID system 380. The logical VBN is mapped to a disk identifier and disk block number (disk, dbn) and sent to an appropriate driver (e.g., SCSI) of the disk driver system 390. The disk driver accesses the dbn from the specified disk and loads the requested data block(s) in memory for processing by the node. Upon completion of the request, the node (and operating system) returns a reply to the client device.

The remote access module 370 is operatively interfaced between the file system module 360 and the RAID system module 380. The remote access module 370 is illustratively configured as part of the file system to implement the functionality to determine whether a newly created data container, such as a subdirectory, should be stored locally or remotely. Alternatively, the remote access module 370 may be separate from the file system. As such, the description of the remote access module being part of the file system should be taken as exemplary only. Further, the remote access module 370 determines which remote flexible volume should store a new subdirectory if a determination is made that the subdirectory is to be stored remotely. More generally, the remote access module 370 implements the heuristics algorithms used for the adaptive data placement. However, it should be noted that the use of a remote access module should be taken as illustrative. In alternative aspects, the functionality may be integrated into the file system or other module of the storage operating system. As such, the description of the remote access module 370 performing certain functions should be taken as exemplary only.

It should be noted that the software “path” through the storage operating system layers described above needed to perform data storage access for the client request received at the node may alternatively be implemented in hardware. That is, a storage access request data path may be implemented as logic circuitry embodied within a field programmable gate array (FPGA) or an application specific integrated circuit (ASIC). This type of hardware implementation increases the performance of the storage service provided by node 200 in response to a request issued by a client device. Alternatively, the processing elements of adapters 225 and 228 may be configured to offload some or all of the packet processing and storage access operations, respectively, from one or both of the processors 222a and 222b, to thereby increase the performance of the storage service provided by the node. It is expressly contemplated that the various processes, architectures and procedures described herein can be implemented in hardware, firmware or software.

As used herein, the term “storage operating system” generally refers to the computer-executable code operable on a computer to perform a storage function that manages data access and may, in the case of a node (e.g., the node 200), implement data access semantics of a general purpose operating system. The storage operating system can also be implemented as a microkernel, an application program operating over a general-purpose operating system, such as UNIX or Windows NT, or as a general-purpose operating system with configurable functionality, which is configured for storage applications as described herein.

In addition, it will be understood to those skilled in the art that aspects of the disclosure described herein may apply to any type of special-purpose (e.g., file server, filer or storage serving appliance) or general-purpose computer, including a standalone computer or portion thereof, embodied as or including a storage system. Moreover, the teachings contained herein can be adapted to a variety of storage system architectures including, but not limited to, a network-attached storage environment, a storage area network and disk assembly directly attached to a client or host computer. The term “storage system” should therefore be taken broadly to include such arrangements in addition to any subsystems configured to perform a storage function and associated with other equipment or systems. It should be noted that while this description is written in terms of a write anywhere file system, the teachings of the subject matter may be utilized with any suitable file system, including a write in place file system.

In an embodiment, the storage server 365 may be embodied as a disk element or disk blade 350 of the storage operating system 210 to service one or more volumes of an array in the storage pod 106. In addition, the multi-protocol engine 325 may be embodied as a network element or network blade 310 to (i) perform protocol termination with respect to a client device issuing incoming data access request packets over the network, as well as (ii) redirect those data access requests to any storage server 365 of the cluster (e.g., the cluster 110). Moreover, the network element 310 and disk element 350 cooperate to provide a highly scalable, distributed storage system architecture of the cluster. To that end, each module may include a cluster fabric (CF) interface module (e.g., CF interface 340a and 340b) adapted to implement intra-cluster communication among the nodes in the cluster. In the context of a convention storage system in which node-level aggregates are employed, the CF protocol may facilitate, among other things, internode communications relating to data access requests. It is to be appreciated such internode communications relating to data access requests may not be needed in the disaggregated storage system 102 in which each node of a cluster may have visibility and access to the entirety of a global PV BN space of the storage pod 106. However, in various embodiments, some limited amount of internode communications, for example, relating to storage space reporting (or simply space reporting) and storage space requests may be useful. Such internode communications may make use of the CF protocol or other forms of internode communications, including message passing via on-wire communications and/or the use of one or more persistent message queues (or on-disk message queues), which may make use of the fact that all nodes can read from all disks of the storage pod. For example, a persistent message queue may be maintained at the node and/or node component-level of granularity in which each node and/or its component has a message queue to which others can post messages destined for the node or its component. In an embodiment, a node component may have an associated inbound queue on which it receives messages sent by another node component (which may be a component of another node) in the cluster and an associated outbound queue on which it posts messages intended for delivery to another node component in the cluster.

The protocol layers, e.g., the NFS/CIFS layers and the ISCSI/IFC layers, of the network element 310 may function as protocol servers that translate file-based and block based data access requests from client devices into CF protocol messages used for communication with the disk element 350. That is, the network element servers may convert the incoming data access requests into file system primitive operations (commands) that are embedded within CF messages by the CF interface module 340 for transmission to the disk elements of the cluster.

Further, in an illustrative aspect of the disclosure, the network element and disk element are implemented as separately scheduled processes of the storage operating system 210. However, in an alternate aspect, the modules may be implemented as pieces of code within a single operating system process. Communication between a network element and disk element may thus illustratively be effected through the use of message passing between the modules although, in the case of remote communication between a network element and disk element of different nodes, such message passing occurs over a cluster interconnect (e.g., the cluster interconnect 108). A known message-passing mechanism provided by the storage operating system to transfer information between modules (processes) is the Inter Process Communication (IPC) mechanism. The protocol used with the IPC mechanism is illustratively a generic file and/or block-based “agnostic” CF protocol that comprises a collection of methods/functions constituting a CF application programming interface (API). Examples of such an agnostic protocol are the SpinFS and SpinNP protocols available from NetApp, Inc.

The CF interface module 340 implements the CF protocol for communicating file system commands among the nodes or modules of a cluster. Communication may be illustratively effected by the disk element exposing the CF API to which a network element (or another disk element) issues calls. To that end, the CF interface module 340 may be organized as a CF encoder and CF decoder. The CF encoder of the CF interface 340a on the network element 310 may encapsulate a CF message as (i) a local procedure call (LPC) when communicating a file system command to a disk element residing on the same node 200 or (ii) a remote procedure call (RPC) when communicating the command to a disk element residing on a remote node of the cluster 110. In either case, the CF decoder of the CF interface 340b on the disk element 350 may de-encapsulate the CF message and process the file system command.

Illustratively, the remote access module 370 may utilize CF messages to communicate with remote nodes to collect information relating to remote flexible volumes. As used herein, a “flexible volume” generally refers to a type of storage volume that may be efficiently distributed across multiple storage devices. A flexible volume may be capable of being resized to meet changing business or application requirements. In some embodiments, a storage system may provide one or more aggregates and one or more storage volumes distributed across a plurality of nodes interconnected as a cluster. Each of the storage volumes may be configured to store data such as files and logical units. As such, in some embodiments, a flexible volume may be comprised within a storage aggregate and further comprises at least one storage device. The storage aggregate may be abstracted over a RAID plex where each plex comprises a RAID group. Moreover, each RAID group may comprise a plurality of storage disks. As such, a flexible volume may comprise data storage spread over multiple storage disks or devices. A flexible volume may be loosely coupled to its containing aggregate. A flexible volume can share its containing aggregate with other flexible volumes. Thus, a single aggregate can be the shared source of all the storage used by all the flexible volumes contained by that aggregate. A non-limiting example of a flexible volume is a NetApp ONTAP FlexVol volume.

A CF message is used for RPC communication between remote modules of the cluster. However, it should be understood that the term “CF message” may be used generally to refer to LPC and RPC communication between modules of the cluster. The CF message includes a media access layer, an IP layer, a UDP layer, a reliable connection (RC) layer and a CF protocol layer. The CF protocol is a generic file system protocol that may convey file system commands related to operations contained within client requests to access data containers stored on the cluster. The CF protocol layer is that portion of a message that carries the file system commands. The CF protocol may be a datagram based and, as such, involves transmission of messages or “envelopes” in a reliable manner from a source (e.g., the network element 310) to a destination (e.g., the disk element 350). The RC layer implements a reliable transport protocol that is adapted to process such envelopes in accordance with a connectionless protocol, such as UDP.

In one embodiment, a data container is represented in the write-anywhere file system as an inode data structure adapted for storage on the disks of a storage pod (e.g., the storage pod 106). In such an embodiment, an inode includes a metadata section and a data section. The information stored in the metadata section of each inode describes the data container (e.g., a file, a snapshot, etc.) and, as such, includes the type (e.g., regular, directory, vdisk) of file, its size, time stamps (e.g., access and/or modification time) and ownership (e.g., user identifier (UID) and group ID (GID), of the file, and a generation number. The contents of the data section of each inode may be interpreted differently depending upon the type of file (inode) defined within the type field. For example, the data section of a directory inode includes metadata controlled by the file system, whereas the data section of a regular inode includes file system data. In this latter case, the data section includes a representation of the data associated with the file.

In an embodiment, the data section of a regular on-disk inode may include file system data or pointers, the latter referencing 4 KB data blocks on disk used to store the file system data. Each pointer is preferably a logical VBN to facilitate efficiency among the file system and the RAID system when accessing the data on disks. Given the restricted size (e.g., 128 bytes) of the inode, file system data having a size that is less than or equal to 64 bytes is represented, in its entirety, within the data section of that inode. However, if the length of the contents of the data container exceeds 64 bytes but less than or equal to 64 KB, then the data section of the inode (e.g., a first level inode) comprises up to 16 pointers, each of which references a 4 KB block of data on the disk.

Moreover, if the size of the data is greater than 64 KB but less than or equal to 64 megabytes (MB), then each pointer in the data section of the inode (e.g., a second level inode) references an indirect block (e.g., a first level L1 block) that contains 224 pointers, each of which references a 4 KB data block on disk. For file system data having a size greater than 64 MB, each pointer in the data section of the inode (e.g., a third level L3 inode) references a double-indirect block (e.g., a second level L2 block) that contains 224 pointers, each referencing an indirect (e.g., a first level L1) block. The indirect block, in turn, contains 224 pointers, each of which references a 4 KB data block on disk. When accessing a file, each block of the file may be loaded from disk into memory (e.g., the memory 224). In other embodiments, higher levels are also possible that may be used to handle larger data container sizes.

When an on-disk inode (or block) is loaded from disk into memory, its corresponding in-core structure embeds the on-disk structure. The in-core structure is a block of memory that stores the on-disk structure plus additional information needed to manage data in the memory (but not on disk). The additional information may include, e.g., a “dirty” bit. After data in the inode (or block) is updated/modified as instructed by, e.g., a write operation, the modified data is marked “dirty” using the dirty bit so that the inode (block) can be subsequently “flushed” (stored) to disk.

According to an embodiment, a file in a file system comprises a buffer tree that provides an internal representation of blocks for a file loaded into memory and maintained by the write-anywhere file system 360. A root (top-level) buffer, such as the data section embedded in an inode, references indirect (e.g., level 1) blocks. In other embodiments, there may be additional levels of indirect blocks (e.g., level 2, level 3) depending upon the size of the file. The indirect blocks (e.g., and inode) include pointers that ultimately reference data blocks used to store the actual data of the file. That is, the data of file are contained in data blocks and the locations of these blocks are stored in the indirect blocks of the file. Each level 1 indirect block may include pointers to as many as 224 data blocks. According to the “write anywhere” nature of the file system, these blocks may be located anywhere on the disks.

In an embodiment, a file system layout is provided that apportions an underlying physical volume into one or more virtual volumes (or flexible volumes) of a storage system, such as the node 200. In such an embodiment, the underlying physical volume is an aggregate comprising one or more groups of disks, such as RAID groups, of the node. The aggregate has its own physical volume block number (PVBN) space and maintains metadata, such as block allocation structures, within that PVBN space. Each flexible volume has its own virtual volume block number (VVBN) space and maintains metadata, such as block allocation structures, within that VVBN space. Each flexible volume is a file system that is associated with a container file. The container file is a file in the aggregate that contains all blocks used by the flexible volume. Moreover, each flexible volume comprises data blocks and indirect blocks that contain block pointers that point at either other indirect blocks or data blocks.

In a further embodiment, PVBNs are used as block pointers within buffer trees of files stored in a flexible volume. This “hybrid” flexible volume example involves the insertion of only the PVBN in the parent indirect block (e.g., inode or indirect block). On a read path of a logical volume, a “logical” volume (vol) info block has one or more pointers that reference one or more fsinfo blocks, each of which, in turn, points to an inode file and its corresponding inode buffer tree. The read path on a flexible volume is generally the same, following PVBNs (instead of VVBNs) to find appropriate locations of blocks. In this context, the read path (and corresponding read performance) of a flexible volume is substantially similar to that of a physical volume. Translation from PV BN-to-disk, dbn occurs at the file system/RAID system boundary of the storage operating system 210.

In a dual VBN hybrid flexible volume example, both a PVBN and its corresponding VVBN are inserted in the parent indirect blocks in the buffer tree of a file. That is, the PVBN and VVBN are stored as a pair for each block pointer in most buffer tree structures that have pointers to other blocks, e.g., level 1 (L1) indirect blocks, inode file level 0 (L0) blocks.

A root (top-level) buffer, such as the data section embedded in an inode, references indirect (e.g., level 1) blocks. Note that there may be additional levels of indirect blocks (e.g., level 2, level 3) depending upon the size of the file. The indirect blocks (and inode) include PVBN/VVBN pointer pair structures that ultimately reference data blocks used to store the actual data of the file. The PVBNs reference locations on disks of the aggregate, whereas the VVBNs reference locations within files of the flexible volume. The use of PVBNs as block pointers in the indirect blocks provides efficiencies in the read paths, while the use of VVBN block pointers provides efficient access to required meta-data. That is, when freeing a block of a file, the parent indirect block in the file contains readily available VVBN block pointers, which avoids the latency associated with accessing an owner map to perform PVBN-to-VVBN translations; yet, on the read path, the PVBN is available.

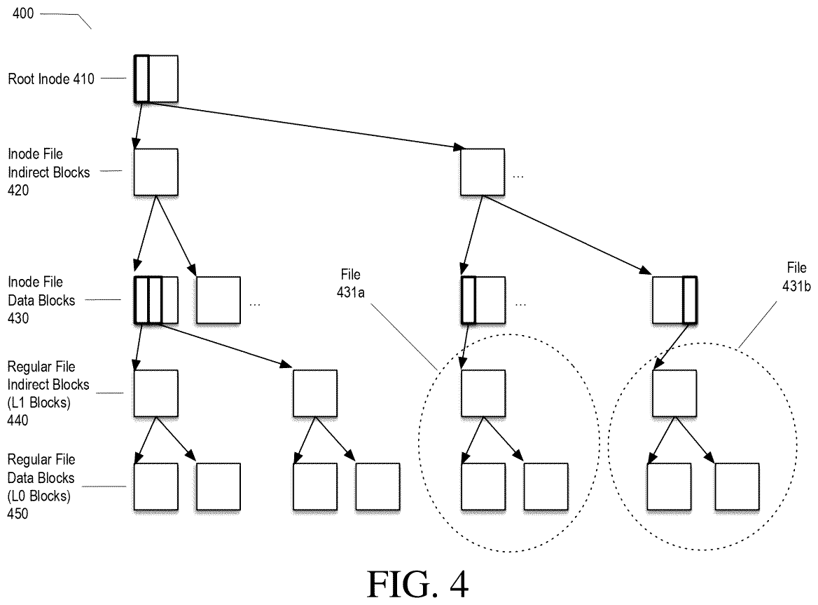

Turning now to FIG. 4, a tree of blocks 400 representing a simplified view of a file system layout in accordance with an embodiment of the present disclosure is shown. In one embodiment, the data storage system nodes make use of a write anywhere file system (e.g., the WAFL file system). The write anywhere file system may represent a UNIX compatible file system that is optimized for network file access. In the context of the present example, the write anywhere file system is a block-based file system that represents file system data (e.g., a block map file and an inode map file), metadata files, and data containers (e.g., volumes, subdirectories, and regular files) in a tree of blocks (e.g., the tree of blocks 400). Keeping metadata in files allows the file system to write meta-data blocks anywhere on disk and makes it easier to increase the size of the file system on the fly.

In this simplified example, the tree of blocks 400 has a root inode 410, which describes an inode map file (not shown), made up of inode file indirect blocks 420 and inode file data blocks 430. In this example, the file system uses inodes (e.g., inode file data blocks 430) to describe data containers representing files (e.g., file 431a and file 431b). In one embodiment, each inode contains 16 block pointers to indicate which blocks (e.g., of 4 KB) belong to a given data container (e.g., a file). Inodes for data containers smaller than 64 KB may use the 156 block pointers to point to file data blocks or simply data blocks (e.g., regular file data blocks, which may also be referred to herein as L0 blocks 450). Inodes for files smaller than 64 MB may point to indirect blocks (e.g., regular file indirect blocks, which may also be referred to herein as L1 blocks 440), which point to actual file data. Inodes for larger files or data containers may point to doubly indirect blocks. For very small files, data may be stored in the inode itself in place of the block pointers.

Turning back to FIG. 1, the disaggregated storage system 102 is designed so that the nodes 112 can have access to the entire storage resources of the storage pod 106 through dynamically extensible file systems (DEFSs) running on the nodes, where each node includes at least one DEFS. In particular, the nodes 112 can have access and can perform input/output (10) operations to the same disk and backend storage via the DEFSs. In order to facilitate these features, the entire accessible storage of the storage pod 106 is divided into units of allocation areas (AAs), where each AA is spread across all the disks in a Redundant Array of Independent Disks (RAID) group and contains multiple blocks, e.g., 4 k blocks. A RAID stripe in this case makes up one 4 k block from each disk and is (stripe) spread across all the disks, and the corresponding AA consists of multiple such consecutive RAID stripes. Each DEFS owns one of more AAs at any point and any AA is only owned by one DEFS at any point to which that DEFS can write. Thus, a single disk can be thought of as being partitioned into chunks, where each chunk belongs to a particular AA that is owned by a single DEFS at any point. The space balancing between DEFSs, and thus, the nodes, continuously moves AA ownership between the DEFSs based on certain policies. Consequently, the blocks in one DEFS can be in an AA that is currently owned by a different DEFS.

As used herein, a “dynamically extensible file system” or a “DEFS” generally refers to a file system of a data pod or a cluster that has visibility into the entire global physical volume block number (PVBN) space of a storage pod and hosts multiple volumes. A DEFS may be thought of as a data container or a storage container (which may be referred to as a storage segment container) to which AAs are assigned, thereby resulting in a more flexible and enhanced version of a node-level aggregate. As described further herein (for example, in connection with automatic space balancing), the storage space associated with one or more AAs of a given DEFS may be dynamically transferred or moved on demand to any other DEFS in the cluster by changing the ownership of the one or more AAs and moving associated AA tracking data structures as appropriate. This provides the unique ability to independently scale each DEFS of a cluster. For example, DEFSs can shrink or grow dynamically over time to meet their respective storage needs and silos of storage space are avoided. DEFSs and AAs are further described below with reference to FIG. 5.

The storage pod 106 may have its own identifier (ID) space for the DEFSs and RAID groups (RGs) in the storage pod. Thus, the storage pod 106 may have its own physical volume block number (PVBN) and/or block ID space.

The DEFSs may use a persistent on-disk area called AA label, which includes a list of AAs and DEFSs that own the AAs. The AA label can be consulted by any DEFS on any node to find out which AA is owned by which DEFS for various scenarios, such as RAID bad disk reconstruction, remote freeing of blocks from AAs not owned by a DEFS and various other operations. Each AA entry in the AA label, which may also identify the RG for that particular AA, will have two owner fields, (1) a proposed owner DEFS ID and (2) a current owner DEFS ID. These owner fields are normally the same and only diverge temporarily when there is AA ownership change in progress.

For each DEFS, there is a DEFS_AAOwnership map file in the file system of that DEFS that authoritatively has the AAs that are owned by that particular DEFS. For AAs not owned by the DEFS, the owner information in the DEFS_AAOwnership map file may be stale and cannot be trusted to get the owner DEFS ID of any AA. In addition, there is also a replicated block called DEFS label for each DEFS, which is outside the file system of that DEFS and writes can be done to the DEFS label without coordinating with the consistency points (CP) related to the DEFS file system. As used herein, a CP or CP operation generally refers to the act of writing data to disk and updating active file system pointers. In various examples, when a file system of a storage system receives a write request, it commits the data to permanent storage before the request is confirmed to the writer. Otherwise, if the storage system were to experience a failure with data only in volatile memory, that data would be lost, and underlying file structures could become corrupted. Physical storage appliances commonly use battery-backed high-speed non-volatile random access memory (NVRAM) as a journaling storage media to journal writes and accelerate write performance while providing permanence, because writing to memory is much faster than writing to storage (e.g., disk). Storage systems may also implement a buffer cache in the form of an in-memory cache to cache data that is read from data storage media (e.g., local mass storage devices or a storage array associated with the storage system) as well as data modified by write requests. In this manner, in the event a subsequent access relates to data residing within the buffer cache, the data can be served from local, high performance, low latency storage, thereby improving overall performance of the storage system. Virtual storage appliances may use NV storage backed by cloud volumes in place of NVRAM for journaling storage and for the buffer cache. Regardless of whether NVRAM or NV storage is utilized, the modified data may be periodically (e.g., every few seconds) flushed to the data storage media. As the buffer cache may be limited in size, an additional cache level may be provided by a victim cache, typically implemented within a slower memory or storage device than utilized by the buffer cache, that stores data evicted from the buffer cache. The event of saving the modified data to the mass storage devices may be referred to as a CP. At a CP, the file system may save any data that was modified by write requests to persistent data storage media.

In an embodiment, the DEFSs in the disaggregated storage system 102 communicate with each other by sending and receiving messages using a persistent message queue (PMQ). Using the PMQ, a DEFS can send messages to other DEFSs and delete received messages from other DEFSs in its local PMQ component (e.g., in the file system), atomically, in its CP. As described below, features of the PMQ are used to make DEFS file system changes atomically with respect to local PMQ operations, such as sending/putting and deleting received messages.

Turning now to FIG. 5, various components of the disaggregated storage system 102 that provides disaggregated storage in accordance with an embodiment of the disclosure are shown. In FIG. 5, only two nodes 112 (i.e., nodes 112a and 112b) of the cluster 110 in the disaggregated storage system 102 are shown. Each of the nodes 112a and 112b includes a single DEFS. The node 112a includes a DEFS 502a, and the node 112b includes a DEFS 502b. The DEFSs 502a and 502b may be used for persisting data on behalf of clients (e.g., the client devices 104). In the illustrated embodiment, the DEFS 502a has been designated as the new-RG-owner DEFS for the storage pod 106.

It should be noted that while for simplicity only the two nodes 112a and 112b, which may be configured as part of a high availability (HA) pair for fault tolerance and nondisruptive operations, are shown in the illustrative cluster depicted in FIG. 5, there may be one or more additional nodes in the cluster 110. For example, there may be multiple HA pairs within the cluster 110. As such, the description of this two-node cluster should be taken as illustrative only. Furthermore, while in some examples, HA may be achieved by defining pairs of nodes within the cluster as HA partners (e.g., with one node designated as the primary node and the other designated as the secondary), in alternative examples any other node within the cluster may be allowed to step in after a failure of a given node without defining HA pairs.

Within the DEFSs 112a and 112b, one or more volumes or other logical storage units may be created by or on behalf of users for hosting/storing their data. In the example shown in FIG. 5, the DEFS 112a includes volumes 504a and 504b, and the DEFS 112b includes volumes 504c and 504d, which are supported by storage resources (e.g., AAs) in the storage pod 106.

While additional data structures may be employed, in this example, each of the DEFSs 112a and 112b is shown being associated with a respective DEFS_AAOwnership map file, which is indexed by AA ID, and an RG data structure in the form of a bitmask, which shows whether the DEFS is the owner of RGs in the storage pod 106. Thus, the DEFS 112a includes a DEFS_AAOwnership map file 506a and an RG bitmask 508a, and the DEFS 112b includes a DEFS_AAOwnership map file 506b and an RG bitmask 508b. In other embodiments, the DEFS_AAOwnership map files 506a and 506b may be storage objects other than files, such as database records, objects in object storage, blocks in block storage, binary large objects (blobs), content-addressable chunks, memory pages or key-value pairs, or other units of storages. Thus, DEFS_AAOwnership map files can be generally referred to as ownership storage objects.

In the disaggregated storage system 102, each DEFS of the nodes 112 has visibility and accessibility into an entire global PVBN address space 510 and any AA (except for a predefined super block AA 512) within the global PVBN address space 510 may be assigned to any DEFS within the cluster 110. By extension, each node has visibility and accessibility into the entire global PVBN address space 510 via its DEFS. The respective DEFS_AAOwnership map files 506a and 506b of the DEFSs 112a and 112b define which PVBNs to which DEFSs have exclusive write access. AAs within the global PVBN space 510 shaded in light gray, such as an AA 514a, can only be written to by the node 112a as a result of their ownership by or assignment to the DEFS 502a. Similarly, AAs within the global PVBN space 510 shaded in dark gray, such as an AA 514b, can only be written to by the node 112b as a result of their ownership by or assignment to the DEFS 502b.

The global PVBN address space 510 of the storage pod 106 is provided by the disks 116 in the storage pod. As shown in FIG. 5, the storage pod 106 includes data disks 516a and a parity disk 518a, which form a RAID group RG0, and data disks 516b and a parity disk 518b, which form a RAID group RG1. Each of the parity disks 518a and 518b includes parity information to provide fault tolerance and data protection. Multiple RAID stripes may then be grouped to form individual AAs. As can be seen in FIG. 5, dividing the storage pod 106 into AAs allows available storage space associated with any given disk or any RAID group to be used across many/all nodes in the cluster 110 without creating silos of space in each node. For example, at the granularity of an individual AA, available storage space within the storage pod 106 may be assigned to any given node in the cluster (e.g., by way of the given node's DEFS). For example, in the context of FIG. 5, the AA 514a and the other AAs shaded in light gray are currently assigned to (or owned by) the DEFS 502a (which has a corresponding light gray shading). Similarly, the AA 514b and the other AAs shaded in dark gray are currently assigned to (or owned by) the DEFS 502b (which has a corresponding light gray shading).

The super block 512 is part of a super block AA (or super AA), which may be the first AA of the storage pod 106. The super AA is not assigned to any DEFS. The super AA may have an array of DEFS areas which are dedicated to each DEFS and can be indexed by a DEFS ID. The DEFS ID may start at index 1 and in the context of the present example includes four super block and four DEFS label blocks, which are the DEFS labels described above. The DEFS label can act as a RAID label for the DEFSs and can be written out of a CP and can store information that needs to be kept outside of the file system. In a pairwise HA configuration, two super blocks and two DEFS label blocks may be used by the hosting node and the other two super blocks and the other two DEFS label blocks may be used by the partner node on takeover. Each of these special blocks may have their own separate stripes.

As shown in FIG. 5, there is also an AA label 516, which includes AA entries for the RAID groups RG0 and RG1 in the storage pod 106. The AA label 516 is persistently stored in the storage pod 106. In an embodiment, each entry in the AA label 516 includes an AA ID, a proposed owner DEFS ID and a current owner DEFS ID. Thus, any DEFS can consult the AA label 516 to determine which AA is owned by which DEFS.

In the example shown in FIG. 5, it is assumed that after establishment of the disaggregated storage within the storage pod 106 and after the original assignment of ownership of AAs to the DEFSs 502a and 502b, some of the AAs have been transferred from the DEFS 502a to the DEFS 502b and/or some of the AAs have been transferred from the DEFS 502b to the DEFS 502a.

Those skilled in the art will appreciate disaggregation of the storage space as discussed herein can be leveraged for cost-effective scaling of infrastructure. For example, the disaggregated storage allows more applications to share the same underlying storage infrastructure. Given that each DEFS represents an independent file system, the use of multiple DEFSs combines to create a cluster-wide distributed file system since all of the DEFSs within a cluster share a global PVBN space (e.g., the global PVBN space 510). This provides the unique ability to independently scale each independent DEFS as well as enables fault isolation and repair in a manner different from existing distributed file systems.

During the initialization of the storage pod 106 on the first node, e.g., the node 106a, a DEFS is designated as a new RG owner during that DEFS creation in the first node. At any point, there may be only one new-RG-owner DEFS for the storage pod. In an embodiment, the change of new RG owner designation from one source DEFS to another target DEFS may be made through manual commands that dictate that the bit indicating the new RG owner in the DEFS label for the target DEFS. However, in other embodiments, the new RG owner change may be made automatically using a software level algorithm. In these embodiments, the new-RG-owner bit may be in a superblock in the file system of the target DEFS.

As noted above, in addition to the new-RG-owner information, the new-RG-owner DEFS also stores an RG bitmask that has one bit for each of the maximum RAID groups that are supported in the storage pod 106. In an embodiment, even if the new-RG-owner designation is changed to a different DEFS, the RG bitmask and any bits for the R Gs set in that RG bitmask stick with the previous or old new-RG-owner DEFS.

When disks are added to backend storage, RAID determines if a new RG needs to be created or if the disks need to be added to an existing RG. If the disks are added to existing RGs, then the size of the corresponding AAs just increases and nothing needs to be done since no new AAs need to be added to the DEFS_AAOwnership map file of the owning DEFS. However, if a new RG is created, then RAID on each node exposes the RG independently to the file system on that node, which may be a write anywhere file layout (WAFL) file system. Thus, there is no coordination between nodes when the new RG is created. When new AAs are created due to the new RG being created by the addition of disks, a disk-add operation is executed to manage the new AAs in an efficient manner, which is described below.

The same disk-add operation can be used if the addition of disks to existing RGs leads to the creation of new AAs. Thus, the disk-add operation can be applied to storage systems that only create AAs due to the addition of disks to new RGs, and also to storage systems that create AAs due to the addition of disks to existing RGs.

As described above, every DEFS maintains a last-PVBN value in a file in its file system, e.g., in an FSINFO file in a WAFL file system, that indicates the last PVBN in the storage pod 106 to which the DEFS has access. Thus, when disks are added to the storage pod 106, the last PVBN in the storage pod is increased, but the last-PVBN value of the DEFSs would remain the same until changed. Thus, whenever the last PVBN of the new-RG-owner DEFS is less than the last PVBN of the storage pod during a CP operation, the new-RG-owner DEFS executes the disk-add operation if the new PVB Ns involve creation of new AA, e.g., due to a new RG. In an embodiment, the disk-add operation is executed during a single CP process.

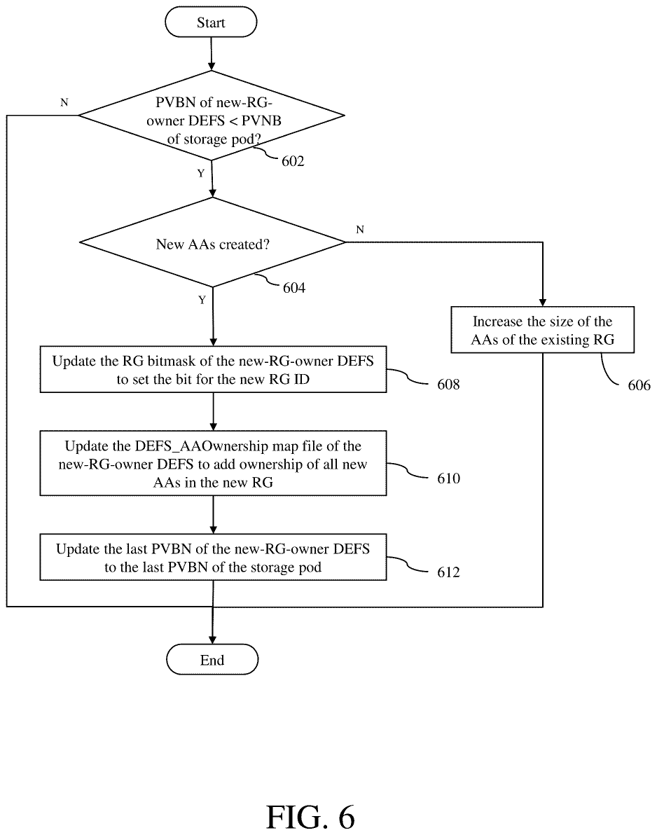

A disk-add operation performed by the new-RG-owner DEFS, e.g., the DEFS 602a, in accordance with an embodiment of the disclosure is described with reference to a flow diagram of FIG. 6. In an embodiment, this disk-add operation is executed during a CP process. The disk-add operation begins at step 602, where a determination is made by the new-RG-owner DEFS whether the last PVBN of the DEFS is less than the last VBN of the storage pod 106, which would indicate that one or more disks have been added to the storage pod 106 since the last time this step was performed (e.g., during the previous CP process). If the last PVBN of the DEFS is not less than the last VBN of the storage pod 106, then the disk-add operation comes to an end. However, if the last PVBN of the DEFS is less than the last VBN of the storage pod 106, then the disk-add operation proceeds to step 604.

At step 604, a determination is made by the new-RG-owner DEFS whether new AAs have been created due to the addition of one or more disks. If no new AAs have been created, this means that the disks have been added to an existing RG. Thus, if new AAs have not been created, then the process proceeds to step 606, where the size of the AAs in the existing RG are increased. The process then proceeds to step 612. However, if new AAs have been created, then the process proceeds to step 608, where the RG bitmask of the new-RG-owner DEFS is updated to set the bit for the new RG ID. In an embodiment, the RG bitmask of the new-RG-owner DEFS is updated before the CP superblock is written. In addition, the RG bitmask may be updated using a synchronous write. As an example, the bit for the new RG ID may be changed to a “1” from the originally set “0”. In some implementations, the RG IDs are never reused.

Next, at step 610, the DEFS_AAOwnership map file of the new-RG-owner DEFS is updated to add ownership of all new AAsi the new RG. In an embodiment, this step is performed as part of the same CP.

Next, at step 612, the last PVBN of the new-RG-owner DEFS is updated to the last PVBN of the storage pod 106. In an embodiment, steps 602-612 may be performed during a single CP process. The disk-add operation then comes to an end.

It is noted here that steps 610 and 612 both involve the file system of the new-RG-owner DEFS. Thus, both steps 610 and 612 are executed or neither of these two steps are executed during the CP process. Thus, any crashes that occur at any point during steps 608-612 can be easily handled. For example, if a crash happens after step 610, then, during DEFS takeover mount, it would be noticed that the last PVBN of the DEFS is again less than the last PVBN of the storage pod 106. In such a situation, step 608 would be executed again, which would be a no operation as the new RG bit is already set in the RG bitmask of the new-RG-owner DEFS. Thus, steps 610 and 612 will be performed.

Additionally, the new-RG-owner DEFS would not perform the costly step of updating the AA label with its DEFS ID for the new RG AAs. Any consumer of the AA label that sees an owner DEFS ID as 0 (i.e., proposed owner==current owner==0) would just simply read the RG bitmasks of all DEFSs in the DEFS labels and easily deduce the owner DEFS. Further, any AA movement, or something like per-DEFS CP before writing to the owned AA for the first time, would first update the owner DEFS ID for the AA in the AA label. Thus, any AAs that have owner DEFS ID as 0 (i.e., proposed owner==current owner ==0) can also be assumed to be pristine and unused. As described below, this is significant for later pointed techniques to be able to immediately distribute pristine (unused) AAs from corrupted DEFSs to other healthy DEFSs without waiting for an inconsistent file system fixer program (e.g., a WAFL-Iron program) to be run.

It is also noted that during the storage pod initialization, the same disk-add operation can be used to just add all the existing RGAAs, including the first RAID group RG0, during the “DEFS creation” itself. As DEFSs and RGs are per storage pod, a fixed ID DEFS can be designated during its creation as the new-RG-owner DEFS (e.g., the first DEFS in the disaggregated storage system 102) and have that DEFS initially own all the existing RG A As through the above disk-add operation. There may be requirements to use fixed number of AAs in the RAID group RG0 for a metadata DEFS (e.g., the first root DEFS) even before the new-RG-owner DEFS can be created. In order to satisfy such requirements, a special AA of the RAID group RG0 may be stored in the new-RG-owner DEFS that indicates where in the RAID group RG0 the AA ownership starts for the new RG owner (e.g., Ownership of “DEFS-ID==0” AAs in the 36). This special AA of the RAID group RG0 may remain even if the new RG owner changes later.

Once the new-RG-owner DEFS gets the ownership of all AAs in the new RG through the DEFS_AA Ownership map file, then a free space balancing mechanism may be employed to distribute the AAs per its distribution policies to other DEFSs, which may be on-demand or average balancing across all DEFSs. This would not require any additional changes to any existing policies in the free space balancing mechanism that distributes AAs across the DEFSs within the storage pod 106.

In at least one embodiment, all other DEFSs will also update their last PVBN for the new RG, similar to step 612. However, only the new RG owner will update its RG bitmask (e.g., to 1) for the new RG and also update its DEFS_AA Ownership map file to own AAs in the new RG, as illustrated in steps 608 and 610.

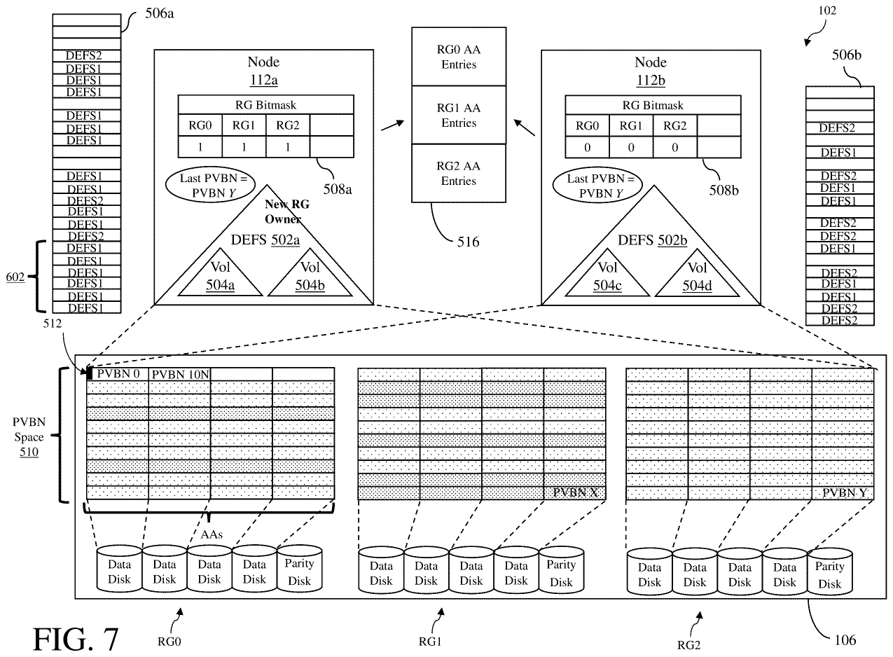

FIG. 7 illustrates the disk-add operation on the disaggregated storage system 102 in accordance with an embodiment of the disclosure. In FIG. 7, four data disks and one parity disk have been added to a new RAID group RG2 in the storage pod 106, which increased the last PVBN of the storage pod from PVBN X to PVBN Y. This means the last PVBN value of the new-RG-owner DEFS is now less than the PVBN value of the storage pod (i.e., PVBN X <PVBN Y). In addition, the AA label 516 has been updated to include AA entries for RAID group RG2. However, these entries have default values, e.g., zeros, and uninitialized. These entries are indicated as being owned by the DEFS 502a since it is the new RG owner. When the disk-add operation is executed, steps 608-612 of FIG. 6 are performed. As a result, the RG bitmask 508a of the new-RG-owner DEFS 602a has been updated so that the bit for the new RG ID, i.e., RG2, is set, e.g., to “1”. In addition, the DEFS_AAOwnership map file 606a of the new-RG-owner DEFS 602a has been updated to add ownership of all new AAs 602 in the RAID group RG2. Lastly, the last PVBN value of the new-RG-owner DEFS 602a has been updated from PVBN X to PVBN Y.

If the new-RG-owner DEFS gets corrupted and is temporarily down for an inconsistent file system fixer program (e.g., the WAFL-Iron program) to be run, then a user can decide to wait for the completion of the inconsistent file system fixer program, and then the disk-add operation can be executed so that the new-RG-owner DEFS takes ownership of any new RGs added when it was down. It is noted here that as part of fixing the file system if the inconsistent file system fixer program consults the AA label to see the latest DEFS owner to assign an AA, it could again lead to determining the DEFS owner from the RG bitmasks of DEFSs, as the AA label entry has owner DEFS-ID==0.

However, since the inconsistent file system fixer program may take a long time to complete, a user may want to simply move any unused/pristine AAs owned by the corrupt DEFS “immediately” to another DEFS. This feature may be very useful in situations when the new-RG-owner or any DEFS goes down soon after owning a very large number of unused AAs due to the disk-add operation or due to space balancing. There could also be cases where a user wants to immediately designate a new-RG-owner DEFS to be able to add a disk shelf immediately while postponing the running of the inconsistent file system fixer program on the existing new RG owner. In such cases, an AA-move operation may be performed, which takes use of the results of the disk-add operation to quickly and efficient move unused AAs owned by the corrupt DEFS.

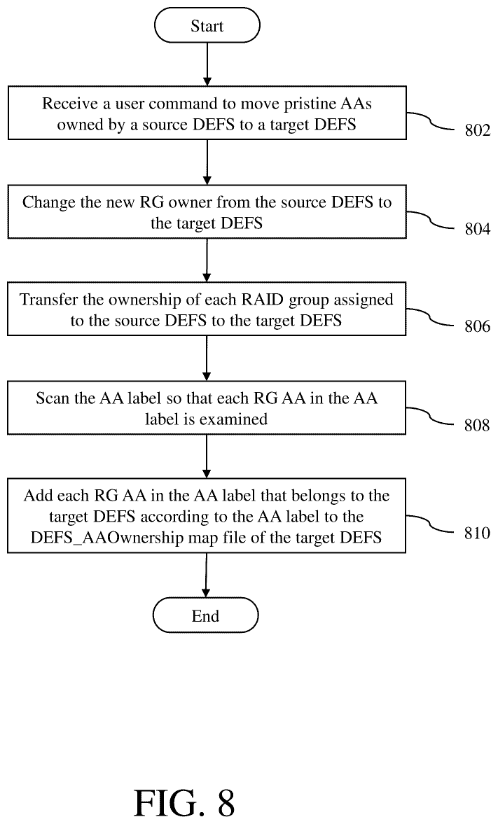

An AA-move operation performed by the controller when a user wants to move any pristine (unused) AAs owned by a corrupt DEFS to a target DEFS in accordance with an embodiment of the disclosure is described with reference to a flow diagram of FIG. 8. In an embodiment, the controller could be a manual user command that invokes the workflow given the source (i.e., corrupt) DEFS and the target DEFS. Alternatively, the controller could be part of software (e.g., ONTAP software) to automatically invoke the workflow based on certain events like some (source) DEFS going down with corruption.

This operation begins at step 802, where a user command to move pristine AAs owned by a source DEFS to a target DEFS is received. The user command can be entered into the disaggregated storage system 102 using any suitable user interface, such as a command-line interface or a graphical user interface user interface. In an embodiment, the user command may include the identifier of the source DEFS and the identifier of the target DEFS.

Next, at step 804, the new RG owner is changed from the source DEFS to the target DEFS. In an embodiment, the new RG owner is changed by clearing the new-RG-owner bit from the DEFS label of the source DEFS, e.g., changing the new-RG-owner bit from “1” to “0”, and setting the new-RG-owner bit in the DEFS label of the target DEFS, e.g., changing the new-RG-owner bit from “0” to “1”. This step may be performed only if the source DEFS is the current new-RG-owner DEFS.

Next, at step 806, the ownership of each RAID group assigned to the source DEFS is transferred to the target DEFS. In an embodiment, the ownership transfer of a RAID group is achieved by clearing the RG bit in the RG bitmask of the DEFS label of the source DEFS for that RAID group and setting the corresponding RG bit in the RG bitmask of the DEFS label of the target DEFS for that RAID group. The RG bit in the RG bitmask of the DEFS label of the source DEFS may be cleared by changing that RG bit from “1” to “0”. Similarly, the corresponding RG bit in the RG bitmask of the DEFS label of the target DEFS may be set by changing that RG bit from “0” to “1”. As an example, if the source DEFS owns the RAID group RG1, the RG bit in the RG bitmask of the DEFS label of the source DEFS for the RAID group RG1 is cleared and the corresponding RG bit in the RG bitmask of the DEFS label of the target DEFS for the RAID group RG1 is set.

Next, at step 808, the AA label is scanned so that each RG AA in the AA label is examined. Next, at step 810, each RG AA in the AA label that belongs to the target DEFS according to the AA label is added to the DEFS_AA Ownership map file of the target DEFS, if the DEFS_AA Ownership map file of the target DEFS does not already contain that AA. Note that as described above any consumers of AA label (e.g., a scan in this case) that see owner DEFS-ID==0 for any AA entry would be given to the DEFS whose RG bit mask has the corresponding RAID group bit set. Thus, since the RAID group bit for any pristine AA that originally belonged to the source DEFS is now set for the target DEFS, any AA with an entry DEFS-ID==0 in the AA label that previously belonged to the source DEFS will be given to the target DEFS.

It is noted that any AAs with owner DEFS ID==0 in the AA label are pristine AAs. Thus, the AA-move operation not only gives ownership of pristine AAs from the RAID groups that belong to the source DEFS to the target DEFS by updating the DEFS_AAOwnership map file and updating the RG bitmask but also ensures that later when the inconsistent file system fixer program (e.g., the WAFL-Iron program) runs and consults the AA label, the inconsistent file system fixer program once again makes the same conclusion that the owner of those AAs is the target DEFS (if the AAs are still pristine) and not the corrupted source DEFS whose DEFS_AA Ownership map file may also have those same AA entries. So the inconsistent file system fixer program will just remove those AAs from the DEFS_AA Ownership map file of the corrupted DEFS. Thus, everything remains consistent.

The disaggregated storage system 102 may be upgraded from an older version that uses a static DEFS ownership scheme for AAs to a new version that uses a dynamic DEFS ownership scheme for AAs. In the static DEFS ownership scheme, there is no space balancing. An example of a static scheme is one that assumes odd AA IDs are assigned to or owned by one DEFS and AAs with even AA IDs are assigned to or owned by some other DEFS, based on DEFS IDs. Thus, the disk-add operation in the static DEFS ownership scheme needs to conform to the static DEFS ownership scheme. Such a disk-add operation is referred to herein as a static disk-add operation or scheme. The disk-add operation in the dynamic DEFS ownership scheme, i.e., the disk-add operation described above with reference to the flow diagram of FIG. 8, is referred to herein as a dynamic disk-add operation or scheme.

In an embodiment, the disaggregated storage system 102 is able to upgrade non-disruptively from the older version that supports the static disk-add scheme to the new version that supports the dynamic disk-add scheme. This feature further needs to handle cases where disks and RAID groups can be added at any point during the upgrade and needs to prevent numerous corner cases that result in corruption because one DEFS with the older version can assume the static disk-add scheme for a new RAID group, while the other DEFS that has been upgraded can assume the non-static disk-add scheme. The reason for these numerous corner cases to handle is that disk-add operation may happen independently for each DEFS because, for each of the nodes discovered by RAIDs, the backend topology containing the RAID group may be exposed. Furthermore, CP operations can happen independently for each DEFS. Thus, this can lead to more than one DEFS assuming self-ownership of the same AA at the same time and writing to that AA, which can cause one or more corruptions if not handled correctly. In order to address this challenge, a handshake operation may be performed, which can handle addition of disks and RAID groups at any point of time during an upgrade process.

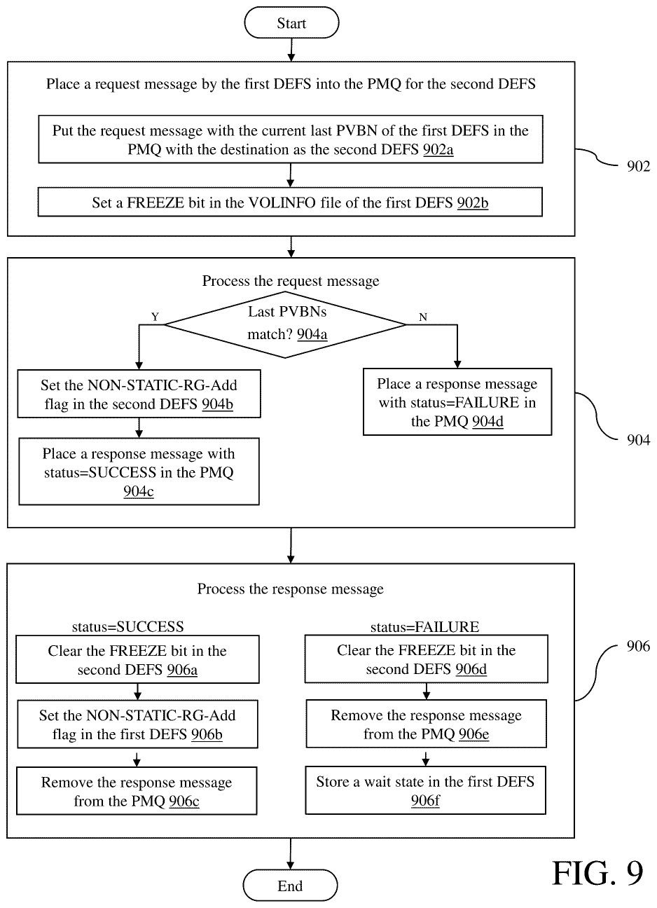

A handshake operation for handling addition of disks during an upgrade process in accordance with an embodiment of the disclosure is described with reference to a flow diagram of FIG. 9. This handshake operation coordinates the shift to the non-static disk-add scheme, where there will be one DEFS already designated as a new RG owner and involved in a disk-add operation, after the new software version is running on all the nodes. Until this handshake operation completes and the corresponding bits (e.g., NON-STATIC-RG-Add bits) are set on the DEFSs, the DEFSs will continue to do static disk-add operations. It is noted here, that in an embodiment, the upgraded software will unconditionally designate one of the DEFSs as the new RG owner by stamping the new-RG-owner bit when the new software comes up on the node. It is noted here that the static disk-add scheme may be used until the NON-STATIC-RG-Add bit is set on the DEFSs that came from the older version. Any new DEFSs created in the new software may have the NON-STATIC-RG-Add bit set during their creation.

The handshake operation begins at step 902, where a request message is placed by the first DEFS into the PMQ for the second DEFS at a point in time. In an embodiment, this point in time may be during the start of some appropriate CP or when no CP is on-going for the first DEFS. In other embodiments, this point in time may be any point in time, except when a CP is being performed for the first DEFS.

In response to the request message being placed in the PMQ, substeps 902a and 902b are executed in an atomic manner, e.g., during a CP of the first DEFS. At substep 902a, the request message with the current last PVBN of the first DEFS is put in the PMQ with the destination as the second DEFS. At substep 902b, a FREEZE bit is set in the VOLINFO file (e.g., in the file system) of the first DEFS so that the PVBN space of the first DEFS does not grow, i.e., not process any new RGs/disks (freezing the last PVBN) until that FREEZE bit is cleared.

Next, at step 904, the request message is processed by the second DEFS at some point in time. In an embodiment, the request message is suspended at the second DEFS if a CP is on-going. When the request message is processed, substeps 904a-904c are executed. At substep 904a, the request message with the last PVBN of the first DEFS is compared with the last PVBN of the second DEFS to determine whether the last PVBN of the first DEFS matches the last PVBN of the second DEFS.

If the last PVBN of the first DEFS does match the last PVBN of the second DEFS, then the following substeps are performed atomically. At substep 904b, the NON-STATIC-RG-Add flag in the VOLINFO file of the second DEFS is set. In an embodiment, the NON-STATIC-RG-Add flag may be set by writing a “1” in the appropriate field of the VOLINFO. At substep 904c, a response message with an internal status set to “SUCCESS” (i.e., status=SUCCESS) that is directed towards the first DEFS is placed in the PMQ.

However, if the last PVBN of the first DEFS does not match the last PVBN of the second DEFS, then, at substep 904d, a response message with an internal status set to “FAILURE” (i.e., status=FAILURE) that is directed towards the first DEFS is placed in the PMQ.

Next, at step 906, the response message is processed by the second DEFS at some point in time. In an embodiment, the response message is suspended at the first DEFS if a CP is on-going. When the response message is processed, substeps 906a-906f are executed. At substep 906a, the status information in the response message is read by the first DEFS to determine whether the status indicates success or failure.

If the status in the response message indicates success, then the following substeps are performed. At substep 906a, the FREEZE bit in VOLINFO of the first DEFS is cleared. In an embodiment, the FREEZE bit may be cleared by writing a “0” in the appropriate field of the VOLINFO. At substep 906b, the NON-STATIC-RG-Add flag in the VOLINFO of the first DEFS is set. In an embodiment, the NON-STATIC-RG-Add flag may be set by writing a “1” in the appropriate field of the VOLINFO. At substep 906c, the response message is removed from the PMQ of the first DEFS. In at least one embodiment, steps 906a, 906b and 906c are atomic due to PMQ atomic guarantees with respect to filesystem CP.

If the status in the response message indicates failure, then the following substeps are performed. At substep 906d, the FREEZE bit in VOLINFO of the first DEFS is cleared. In an embodiment, the FREEZE bit may be cleared by writing a “0” in the appropriate field of the VOLINFO. At substep 906e, the response message is removed from the PMQ of the first DEFS. At optional substep 906f, a wait state is stored in-core of the first DEFS so that the first DEFS will send another request message after a few CPs to give some time for both the first and second DEFSs to grow their last PVBN. In an embodiment, the first DEFS will not initiate the request message if the FREEZE bit is set on itself or the NON-STATIC-RG-Add flag or bit is already set. In at least one embodiment, steps 906d and 906e are atomic due to PMQ atomic guarantees with respect to filesystem CP.

During an upgrade, a crash can happen at different points when a disk-add operation is being executed. The above handshake operation is able to handle a crash that occurs at any time during the upgrade. Two example scenarios involving crashes and how the crashes are handled by the handshake operation are described below.

The first example in accordance with an embodiment of the disclosure involves a crash that occurs after the handshake operation has completed and after a CP superblock for the second DEFS is written in response to a new RG during a CP operation for the second DEFS. The sequence for this example is as follows. First, the handshake operation is completed successfully. This means that the FREEZE bit on the first DEFS VOLINFO is cleared (substep 906a), the NON-STATIC-RG-Add flag/bit is set on the first DEFS VOLINFO (substep 906b) and the response message has been removed from the first DEFS PMQ (substep 906c). Next, a CP operation for the first DEFS is started and the new RG is noticed. In response, the new RG AAs are added in non-static manner during the CP operation by updating the RG bitmask of the first DEFS, the DEFS_AA Ownership map file of the first DEFS, etc., as explained above with respect to a disk-add operation. In addition, file system updates, such as DEFS_AA Ownership map file update, are made in the current CP operation of the first DEFS or in subsequent CP operations of the first DEFS, if multiple CP operations are needed for the disk-add operation to be completed. In this example, a crash then occurs after the CP superblock is written, which means that the clearing of the FREEZE bit on the first DEFS VOLINFO and the setting of the NON-STATIC-RG-Add flag/bit on the first DEFS VOLINFO are persistently written or recorded.

In this scenario, the new RG will be seen by the first DEFS as part of the mounting process (e.g., DEFS online process) and the new RG is consumed by the first DEFS in a non-static manner since the first DEFS will see that the NON-STATIC-RG-Add flag is set. Note that the FREEZE bit is NOT set at that point because clearing of that bit had persisted (substep 906a).

The second example is a crash that occurs after the handshake operation has completed and but before the CP superblock is written in response to the new RG during a CP operation in accordance with an embodiment of the disclosure. Since the crash occurred before the CP superblock was written and the CP operation has NOT been completed, the FREEZE bit is still set for the first DEFS. Again, the new RG will be seen by the first DEFS as part of the mounting process (e.g., DEFS online process). However, the FREEZE bit of the first DEFS is still set. Therefore, the new RG is not added because the last PVBN of the first DEFS cannot grow due to the set FREEZE bit. Thus, the addition of the new RG is postponed and the first DEFS mount is completed.

Now, the PMQ response message is then executed and substeps 906a-906c are successfully executed, which means that the FREEZE bit is cleared and the NON-STATIC-RG-Add flag is set. During the next CP operation, the new RG and the condition that the last PVBN of the first DEFS is less than the last PVBN of the storage pod 106 are detected. Thus, the new RG is added in a non-static manner since the FREEZE bit is cleared and the first DEFS last PVBN can now increase or grow.

Various crashes can also be handled in a similar manner for the request message processing on the second DEFS side.

The above handshake operation may be modified to be used to dynamically and automatically coordinate without manual intervention to change the new RG owner from one DEFS to another without any corruptions, all the while allowing disks and RAID groups to be added during this change of new RG owner. This change of new RG owner may be useful in cases where one wants to remove/delete DEFSs without parking deleted node DEFSs on other nodes post node removal. Alternatively, the inconsistent file system fixer program (e.g., the WAFL-Iron program) may execute this operation to change the new RG owner to another DEFS before even starting the fixing process of the existing corrupted new-RG-owner DEFSs file system. In an embodiment, the new-RG-owner bit and the RG bitmask may be stored in the file system, e.g., in a superblock of the file system, instead of being stored in the DEFS label.

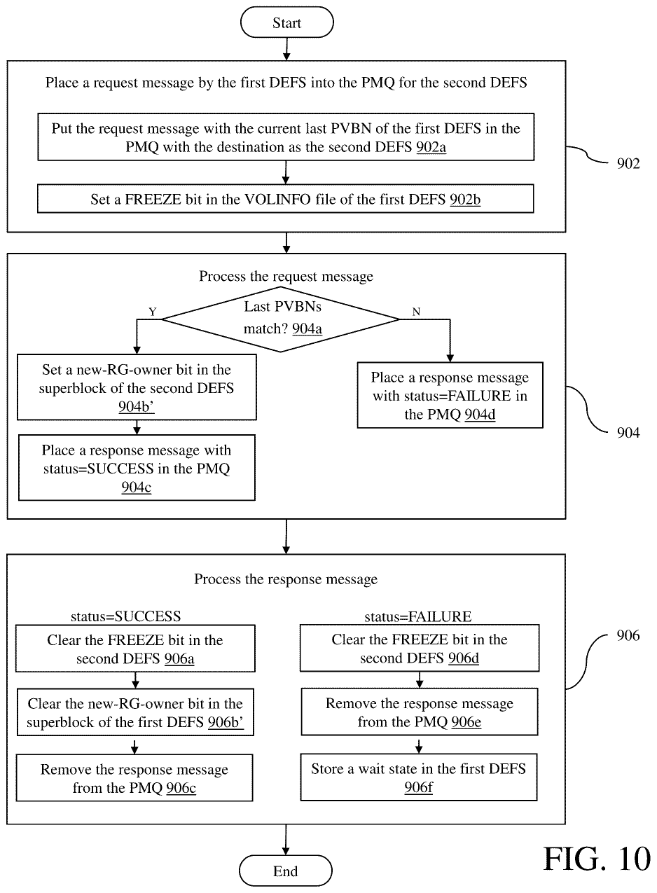

A handshake operation to change the new RG owner from a first DEFS to a second DEFS in accordance with an embodiment of the disclosure is described with reference to a flow diagram of FIG. 10. This handshake operation is similar to the handshake operation of FIG. 9. However, there are two modifications. The first modification is that substep 904b is replaced by substep 904b′, where a new-RG-owner bit in the superblock of the second DEFS is set, instead of setting the NON-STATIC-RG-Add flag. The second modification is that substep 906b is replaced by substep 906b′, where the new-RG-owner bit in the superblock of the first DEFS is cleared, instead of setting the NON-STATIC-RG-Add flag. The reason for using “superblock” instead of “DEFS label” for this operation is because the superblock is part of the filesystem (unlike the DEFS label), which ensures the use of the PMQ guarantees of atomicity with respect to filesystem CP and thus for the setting of the new-RG-owner bit.

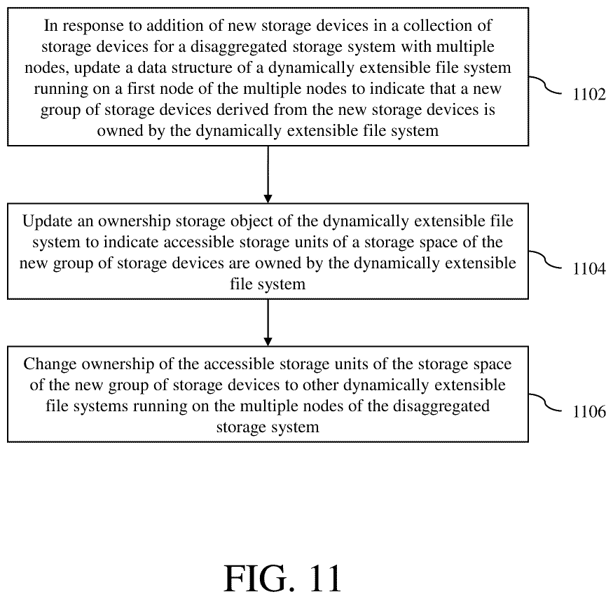

A method executed by one or more processors in accordance with an embodiment of the disclosure is now described with reference to a flow diagram of FIG. 11. At block 1102, in response to addition of new storage devices in a collection of storage devices for a disaggregated storage system with multiple nodes, a data structure of a dynamically extensible file system running on a first node of the multiple nodes is updated to indicate that a new group of storage devices derived from the new storage devices is owned by the dynamically extensible file system. At block 1104, an ownership storage object of the dynamically extensible file system is updated to indicate accessible storage units of a storage space of the new group of storage devices are owned by the dynamically extensible file system. At block 106, the ownership of the accessible storage units of the storage space of the new group of storage devices is changed to other dynamically extensible file systems running on the multiple nodes of the disaggregated storage system.

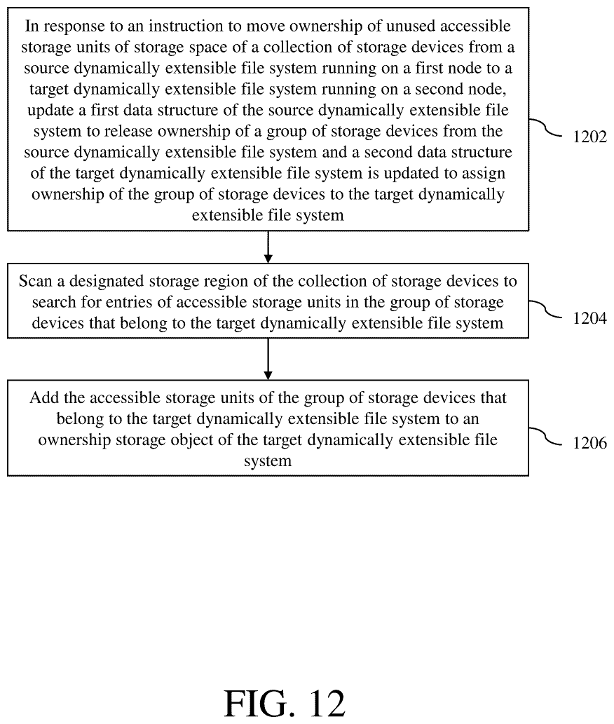

Another method executed by one or more processors in accordance with an embodiment of the disclosure is now described with reference to a flow diagram of FIG. 12. At block 1202, in response to an instruction to move ownership of unused accessible storage units of storage space of a collection of storage devices from a source dynamically extensible file system running on a first node to a target dynamically extensible file system running on a second node, a first data structure of the source dynamically extensible file system is updated to release ownership of a group of storage devices from the source dynamically extensible file system and a second data structure of the target dynamically extensible file system is updated to assign ownership of the group of storage devices to the target dynamically extensible file system. The first and second data structures are accessible to the first and second nodes. At block 1204, a designated storage region of the collection of storage devices is scanned to search for entries of accessible storage units of the group of storage devices that belong to the target dynamically extensible file system, wherein the entries of the accessible storage units of the new group of storage devices having a predefined value are identified as belong to the target dynamically extensible file system when the second data structure of the target dynamically extensible file system indicates the ownership of the group of storage devices. At block 1206, the accessible storage units of the new group of storage devices that belong to the target dynamically extensible file system are added to an ownership storage object of the target dynamically extensible file system.

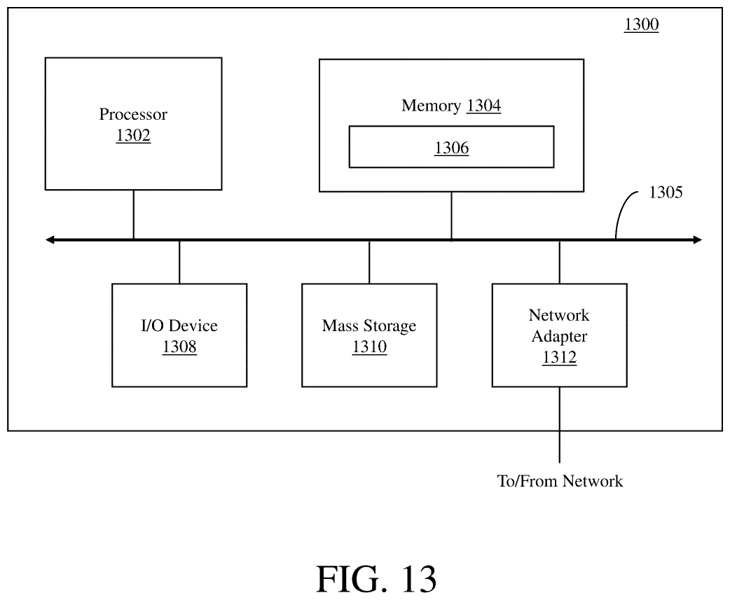

FIG. 13 is a high-level block diagram showing an example of the architecture of a processing system 1300 in accordance with an embodiment of the invention, in which executable instructions for operations as described above can be implemented. The processing system 1300 can represent one or more components in the computing environment 100 described herein. Note that certain standard and well-known components which are not germane to the present invention are not shown in FIG. 13.

The processing system 1300 includes one or more processors 1302 and memory 1304, coupled to a bus system 1305. The bus system 1305 shown in FIG. 13 is an abstraction that represents any one or more separate physical buses and/or point-to-point connections, connected by appropriate bridges, adapters and/or controllers. The bus system 1305, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processors 1302 are the central processing units (CPUs) of the processing system 1300 and, thus, control its overall operation. In certain aspects, the processors 1302 accomplish this by executing programmable instructions stored in the memory 1304. Each processor 1302 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 1304 represents any form of random-access memory (RAM), read-only memory (ROM), flash memory, or the like, or a combination of such devices. The memory 1304 includes the main memory of the processing system 1300. Instructions 1306 which implement techniques introduced above may reside in and may be executed by the processors 1302 from the memory 1304. For example, the instructions 1306 may include code used for executing at least some of steps of methods or operations described herein, as well running various applications/processes running in the computing environment 100.

Also connected to the processors 1302 through the bus system 1305 are one or more internal mass storage devices 1310, and a network adapter 1312. The internal mass storage devices 1310 may be or may include any conventional medium for storing large volumes of data in a non-volatile manner, such as one or more magnetic or optical based disks. The network adapter 1312 provides the processing system 1300 with the ability to communicate with remote devices (e.g., storage servers) over a network and may be, for example, an Ethernet adapter, a Fibre Connector (FC) adapter, or the like. The processing system 1300 also includes one or more input/output (I/O) devices 1308 coupled to the bus system 1305. The I/O devices 1308 may include, for example, a display device, a keyboard, a mouse, etc.

Note that references throughout this specification to “one aspect” or “an aspect” mean that a particular feature, structure or characteristic described in connection with the aspect is included in at least one aspect of the present disclosure. Therefore, it is emphasized and should be appreciated that two or more references to “an aspect” or “one aspect” or “an alternative aspect” in various portions of this specification are not necessarily all referring to the same aspect. Furthermore, the particular features, structures or characteristics being referred to may be combined as suitable in one or more aspects of the present disclosure, as will be recognized by those of ordinary skill in the art.

Similarly, reference throughout this specification to “one embodiment,” “an embodiment,” or similar language means that a particular feature, structure, or characteristic described in connection with the indicated embodiment is included in at least one embodiment of the present disclosure. Thus, the phrases “in one embodiment,” “in an embodiment,” and similar language throughout this specification may, but do not necessarily, all refer to the same embodiment.

While the present disclosure is described above with respect to what is currently considered its preferred aspects, it is to be understood that the disclosure is not limited to that described above. To the contrary, the disclosure is intended to cover various modifications and equivalent arrangements within the spirit and scope of the appended claims.

1. A method executed by one or more processors, comprising:
in response to an instruction to move ownership of unused accessible storage units of storage space of a collection of storage devices from a source file system running on a first node of a disaggregated storage system to a target file system running on a second node of the disaggregated storage system, updating a first data structure of the source file system to release ownership of a group of storage devices from the source file system and a second data structure of the target file system to assign ownership of the group of storage devices to the target file system, wherein the group of storage devices represents a Redundant Array of Independent Disks (RAID) group within the collection of storage devices;
scanning a designated storage region of the collection of storage devices to search for entries of accessible storage units in the group of storage devices that belong to the target file system; and
adding the accessible storage units of the group of storage devices that belong to the target file system to an ownership storage object of the target file system.

2. The method of claim 1, wherein at least one of the first and second data structures is a bitmask, where each bit in the bitmask corresponds to a different group of storage devices.

3. The method of claim 1, wherein the ownership storage object includes entries of accessible storage units owned by the target file system.

4. The method of claim 1, wherein the designated storage region includes a persistent on-disk area that includes a list of accessible storage units and file systems that own the accessible storage units in the list of accessible storage units.

5. The method of claim 1, further comprising changing a new disk group owner from the source file system to the target file system.

6. The method of claim 5, wherein changing the new disk group owner includes updating file system label blocks of the source and target file systems.

7. The method of claim 4, wherein each of the accessible storage units in the group of storage devices that belong to the target file system includes an owner file system set to a predefined value in an associated entry of the designated storage region.

8. The method of claim 7, wherein updating the first and second data structures includes updating a first bitmask of the source file system to release ownership of the group of storage devices from the source file system and a second bitmask of the target extensible file system to assign ownership of the group of storage devices to the target file system, wherein scanning the designated storage region includes scanning a persistent on-disk area that includes the list of accessible storage units and the file systems that own the accessible storage units in the list of accessible storage units, and wherein adding the accessible storage units includes adding each of the accessible storage units of the group of storage devices that includes an owner file system set to zero in the associated entry of the designated storage region to the ownership storage object of the target file system.

9. A non-transitory computer-readable storage medium containing program instructions, wherein execution of the program instructions by one or more processors of a disaggregated storage system causes the one or more processors to perform steps comprising:
in response to an instruction to move ownership of unused accessible storage units of storage space of a collection of storage devices from a source file system running on a first node of the disaggregated storage system to a target file system running on a second node of the disaggregated storage system, updating a first data structure of the source file system to release ownership of a group of storage devices from the source file system and a second data structure of the target file system to assign ownership of the group of storage devices to the target file system, wherein the group of storage devices represents a Redundant Array of Independent Disks (RAID) group within the collection of storage devices;
scanning a designated storage region of the collection of storage devices to search for entries of accessible storage units in the group of storage devices that belong to the target file system; and
adding the accessible storage units of the group of storage devices that belong to the target file system to an ownership storage object of the target file system.

10. The non-transitory computer-readable storage medium of claim 9, wherein at least one of the first and second data structures is a bitmask, where each bit in the bitmask corresponds to a different group of storage devices.

11. The non-transitory computer-readable storage medium of claim 9, wherein the ownership storage object includes entries of accessible storage units owned by the target file system.

12. The non-transitory computer-readable storage medium of claim 9, wherein the designated storage region includes a persistent on-disk area that includes a list of accessible storage units and file systems that own the accessible storage units in the list of accessible storage units.

13. The non-transitory computer-readable storage medium of claim 9, wherein the steps further comprise changing a new disk group owner from the source file system to the target file system.

14. The non-transitory computer-readable storage medium of claim 13, wherein changing the new disk group owner includes updating file system label blocks of the source and target file systems.

15. The non-transitory computer-readable storage medium of claim 12, wherein each of the accessible storage units in the group of storage devices that belong to the target file system includes an owner file system set to a predefined value in an associated entry of the designated storage region.

16. The non-transitory computer-readable storage medium of claim 15, wherein updating the first and second data structures includes updating a first bitmask of the source file system to release ownership of the group of storage devices from the source file system and a second bitmask of the target file system to assign ownership of the group of storage devices to the target file system, wherein scanning the designated storage region includes scanning a persistent on-disk area that includes the list of accessible storage units and the file systems that own the accessible storage units in the list of accessible storage units, and wherein adding the accessible storage units includes adding each of the accessible storage units of the group of storage devices that includes an owner file system set to zero in the associated entry of the designated storage.

17. A disaggregated storage system comprising:
memory; and
at least one processor configured to:
in response to an instruction to move ownership of unused accessible storage units of storage space of a collection of storage devices from a source file system running on a first node of the disaggregated storage system to a target file system running on a second node of the disaggregated storage system, update a first data structure of the source file system to release ownership of a group of storage devices from the source file system and a second data structure of the target file system to assign ownership of the group of storage devices to the target file system, wherein the group of storage devices represents a Redundant Array of Independent Disks (RAID) group within the collection of storage devices;
scan a designated storage region of the collection of storage devices to search for entries of accessible storage units in the group of storage devices that belong to the target file system; and
add the accessible storage units of the group of storage devices that belong to the target file system to an ownership storage object of the target file system.

18. The disaggregated storage system of claim 17, wherein at least one of the first and second data structures is a bitmask, where each bit in the bitmask corresponds to a different group of storage devices.

19. The disaggregated storage system of claim 17, wherein the designated storage region includes a persistent on-disk area that includes a list of accessible storage units and file systems that own the accessible storage units in the list of accessible storage units.

20. The system of claim 17, wherein each of the accessible storage units in the group of storage devices that belong to the target file system includes an owner file system set to a predefined value in an associated entry of the designated storage region.
